(19) United States
(12) Patent Application Publication
(10) Pub. No.: US 2006/0291701 A1
(43) Pub. Date: Dec. 28, 2006

(54) User discrimination system, user discrimination method and storage medium storing a program

(75) Inventor: Kei Tanaka, Minato-ku (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/261,759

(22) Filed: Oct. 31, 2005

(30) Foreign Application Priority Data
Jun. 27, 2005 (JP) 2005-186898

(51) Int. Cl. G06K 9/00; G05B 19/00

(52) U.S. Cl. 382/115; 340/5.2

(57) ABSTRACT

A user discrimination system includes a database to store a correspondence between a pen device and feature information of a rightful user of the pen device, a database management part to acquire, when the pen device is used, the feature information corresponding to the pen device from the database, and a judgment part to judge, based on the feature information acquired from the database and feature information of a user of the pen device acquired from the pen device, whether the user is the rightful user.

### BACKGROUND OF THE INVENTION

(1) Field of the Invention

The present invention relates to a user discrimination system for judging whether a rightful user uses a pen device, a user discrimination method, and a storage medium storing a program.

(2) Description of the Related Art

In recent years, attention is paid to a technique in which a character or a picture is drawn on a special sheet on which fine dots are printed, a user transfers data such as the character written on the sheet to a personal computer, a cellular phone or the like, and the content can be stored or can be transmitted by mail. In this technique, small dots are printed at intervals of, for example, approximately 0.3 mm on the special sheet, and these describe patterns all different for every grid with a specified size. These are read by, for example, a dedicated pen having a built-in digital camera, so that the position of the character or the like written on the special sheet can be specified, and the character or the like as stated above can be used as electronic information.

Besides, this technique can also be used for providing various services to a user. In that case, it is conceivable that a specific service is provided for only a specific user. Since the user receives the provision of the service by using the foregoing dedicated pen, according to one method, a judgment is made, based on identification information of the pen, as to whether the service may be provided for a certain user. However, even if such a method is adopted, it is not guaranteed that the pen is used by a rightful user. Accordingly, it is very important to judge whether the user of the pen is the rightful user.

Here, as the related art disclosed in publications, there is a technique in which an electronic signature is performed by using a private key corresponding to hand writing information inputted from a pen device. Specifically, the handwriting information of a handwritten signature by the pen device is transmitted to a signature apparatus, the signature apparatus judges whether a person having performed the handwritten signature is the owner himself/herself of the private key, and when the person is confirmed to be the owner himself/herself, the electronic signature is performed using the private key corresponding to the handwriting information.

However, the technique described above is such that it is judged whether the user of the pen device is the owner of the private key, and is not such that it is judged whether the user is the rightful user (person permitted to use the pen device).

Accordingly, there has been a problem that it is uncertain whether a pen device is used by a rightful user.

### SUMMARY OF THE INVENTION

The present invention has been made in view of the above circumstances and provides a user discrimination system for judging whether a pen device is used by a rightful use.

According to an aspect of the invention, a user discrimination system includes a database to store a correspondence between a pen device and feature information of a rightful user of the pen device, a database management part to acquire, when the pen device is used, the feature information corresponding to the pen device from the database, and a judgment part to judge, based on the feature information acquired from the database and feature information of a user of the pen device acquired from the pen device, whether the user is the rightful user.

### BRIEF DESCRIPTION OF THE DRAWINGS

Embodiments of the invention will be described in detail based on the following figures, wherein:

FIG. 1 is a view showing the whole structure of a system to which an embodiment of the invention is applied;

FIG. 2 is a block diagram showing a functional structure of an identification information management server in the embodiment of the invention;

FIGS. 3A to 3C are views for explaining a two-dimensional code image printed on a medium in the embodiment of the invention;

FIG. 4 is a view showing a structure of a system in a first embodiment of the invention;

FIG. 5 is a view showing an example of the content of a pen information DB in the embodiment of the invention;

FIG. 6 is a flowchart showing an operation of a user discrimination processing in the first embodiment of the invention;

FIG. 7 is a view showing a structural example of a pen device in the embodiment of the invention;

FIG. 8 is a flowchart showing an operation of the pen device in the embodiment of the invention;

FIG. 9 is a view showing a structure of a system in a second embodiment of the invention; and

FIG. 10 is a flowchart showing an operation of a user discrimination processing in the second embodiment of the invention.

### DETAILED DESCRIPTION OF THE INVENTION

Hereinafter, an embodiment of the invention will be described in detail with reference to the accompanying drawings.

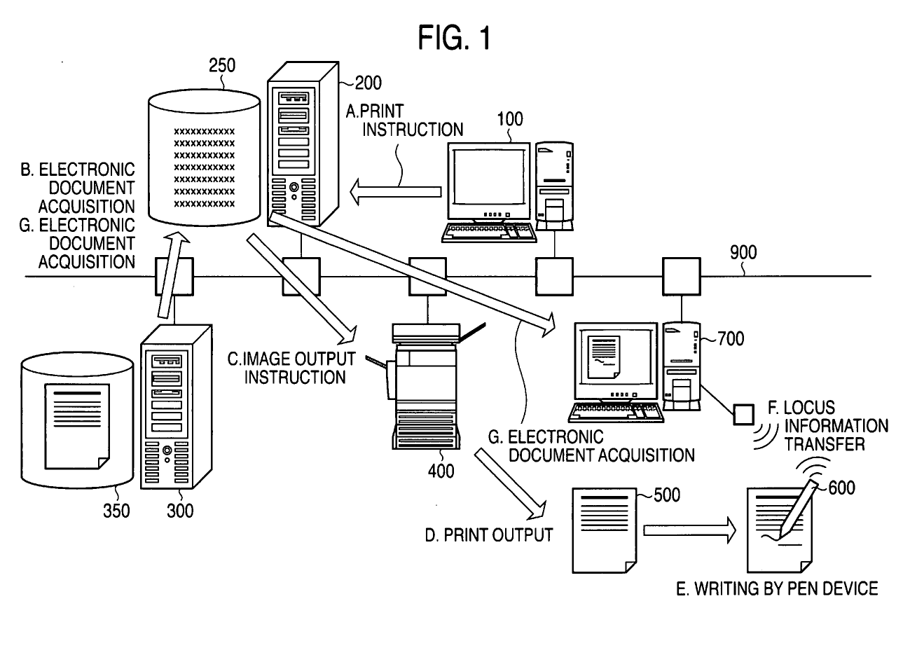

FIG. 1 shows an example of a structure of a system to which this embodiment is applied. This system is constructed by connecting a network 900 with at least a terminal apparatus 100 to instruct printing of an electronic document, an identification information management server 200 that manages identification information to be given to a medium when an electronic document is printed and creates an image in which a code image including this identification information and the like is superimposed on an image of the electronic document, a document management server 300 to manage an electronic document, and an image forming apparatus 400 to print the image in which the code image is superimposed on the image of the electronic document.

Besides, the identification information management server 200 is connected with an identification information repository 250 as a storage apparatus to store identification information, and the document management server 300 is connected with a document repository 350 as a storage apparatus to store electronic documents.

Further, this system includes a printed material 500 outputted in the image forming apparatus 400 by the instruction from the terminal apparatus 100, and a pen device 600 to record a character or a figure on the printed material 500 and to read recording information of the character or the figure. Besides, the network 900 is also connected with a terminal apparatus 700 to superimpose the recording information read by the pen device 600 on the electronic document managed by the document management server 300 and to display them.

Incidentally, in the present specification, although the word of “electronic document” is used, this does not mean only what is obtained by computerizing a “document” including a text. For example, the “electronic document” includes image data (irrespective of raster data or vector data), such as a picture, photograph or figure, and other printable electronic data.

Hereinafter, the outline of an operation of this system will be described.

First, the terminal apparatus 100 instructs the identification information management server 200 to superimpose a code image on an image of an electronic document managed by the document repository 350 and to print them (A). At this time, print attributes, such as a sheet size, direction, reduction/enlargement, N-up (printing in which N pages of an electronic document are laid out on one page of a sheet) and duplex printing, are also inputted from the terminal apparatus 100.

By this, the identification information management server 200 acquires, from the document management server 300, the electronic document whose printing is instructed (B). The identification information management server attaches the identification information managed by the identification information repository 250 and the code image including position information determined in accordance with the print attributes to the image of the acquired electronic document, and instructs the image forming apparatus 400 to print it (C). Incidentally, here, the identification information is information to uniquely identify each medium (sheet) on which an image of an electronic document is printed, and the position information is information to specify a coordinate position (X coordinate, Y coordinate) on each medium.

Thereafter, the image forming apparatus 400 outputs the printed material 500 in accordance with the instruction from the identification information management server 200 (D).

Incidentally, although described later in detail, it is assumed that the image forming apparatus 400 forms the code image attached in the identification information management server 200 as an invisible image with an invisible toner, and forms the other image (image of a portion included in the original electronic document) as a visible image with a visible toner.

On the other hand, it is assumed that the user uses the pen device 600 to record (write) a character or a figure on the printed material 500 (E). By this, an image pickup device of the pen device 600 picks up a definite area on the printed material 500, and acquires the position information and the identification information. Then, locus information of the character or the figure obtained based on the position information and the identification information are transferred to the terminal apparatus 700 by wireless or wire (F). Incidentally, in this system, the invisible image is formed using the invisible toner whose absorption rate of infrared light is higher than a specified standard, and the invisible image can be read by the pen device 600 capable of irradiating and detecting the infrared light.

Thereafter, the terminal apparatus 700 transmits the identification information to the identification information management server 200, and requests the transmission of an electronic document corresponding to this identification information. When receiving this request, the identification information management server 200 acquires the electronic document corresponding to the identification information from the document management server 300, and transmits it to the terminal apparatus 700 (G). As a result, the electronic document transmitted from the identification information management server 200 and the locus information transmitted from the pen device 600 are synthesized and displayed on the terminal apparatus 700.

However, the structure as stated above is merely an example, and one server may have the function of the identification information management server 200 and the function of the document management server 300, or the function of the identification information management server 200 may be realized by an image processing part of the image forming apparatus 400.

Next, the structure and operation of this system will be described in more detail.

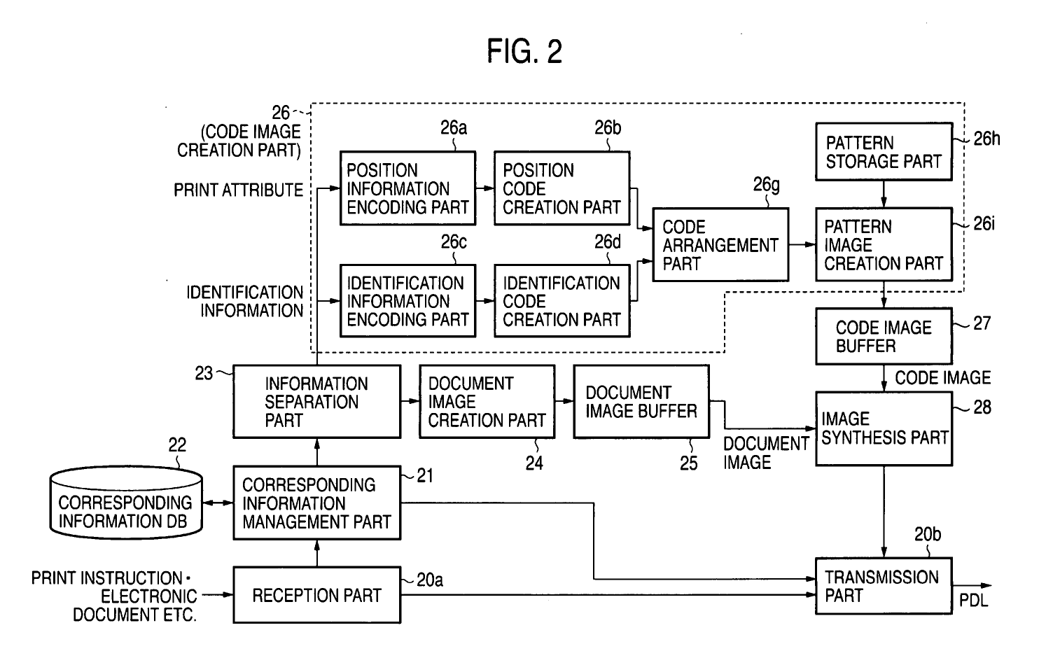

FIG. 2 is a view showing an example of a structure of the identification information management server 200.

The identification information management server 200 includes a reception part 20a, a correspondence information management part 21, a correspondence information database (DB) 22, an information separation part 23, a document image creation part 24, a document image buffer 25, a code image creation part 26, a code image buffer 27, an image synthesis part 28, and a transmission part 20b.

Besides, the code image creation part 26 includes a position information encoding part 26a, a position code creation part 26b, an identification information encoding part 26c, an identification code creation part 26d, a code arrangement part 26g, a pattern storage part 26h, and a pattern image creation part 26i.

The reception part 20a receives various information, such as a print instruction and an electronic document of a print object, from the network 900.

The correspondence information management part 21 performs the registration of information into the correspondence information DB 22 and the readout of information from the correspondence information DB 22. The correspondence information DB 22 is the database to store correspondence of identification information to identify a medium, storage place of an electronic document as the origin of an image printed on the medium, and the like.

The information separation part 23 separates information delivered from the correspondence information management part 21 into information necessary for creation of the document image and information necessary for creation of the code image.

The document image creation part 24 creates an image of the electronic document based on the information necessary for the creation of the document image separated by the information separation part 23, and stores it into the document image buffer 25.

The code image creation part 26 creates the code image based on the information necessary for the creation of the code image separated by the information separation part 23, and stores it into the code image buffer 27.

The image synthesis part 28 synthesizes the document image stored in the document image buffer 25 and the code image stored in the code image buffer 27.

The transmission part 20b transmits the instruction to output the image after the synthesis by the image synthesis part 28 as PDL (Page Description Language) typified by Postscript or the like to the image forming apparatus 400.

The position information encoding part 26a encodes the position information by a specified encoding system. For this encoding, for example, an RS (Reed-Solomon) code as a well-known error correction code or a BCH code can be used. Besides, as an error detection code, CRC (Cyclic Redundancy Check) of the position information or a check sum value is calculated, and it can also be added as a redundant bit to the position information. Besides, an M-series code as a kind of pseudo noise series can also be used as the position information. In the M-series code, encoding is performed by using such a property that in the case of a Pth-order M series (series length is 2^{P-1}), when a partial series of length P is extracted from the M series, a bit pattern appearing in the partial series appears in the M series only once.

The position code creation part 26b converts the encoded position information into a format of embedding as code information. For example, the arrangement of respective bits in the encoded position information is changed or encrypted by a pseudo random number or the like, so that decoding by a third party becomes difficult. Besides, in the case where the position code is two-dimensionally arranged, bit values are two-dimensionally arranged similarly to the arrangement of the code.

Incidentally, in this embodiment, the position information encoding part 26a selects encoding position information corresponding to the print attribute delivered from the information separation part 23 among encoding position information previously created and stored for each print attribute. This is because when print attributes such as sheet size, direction, reduction/enlargement, and N-up are determined, one position code printed on the sheet can be specified.

On the other hand, in the case where the print attribute is always identical, the position code printed on the sheet becomes always identical. Accordingly, in the case where only printing with the same print attribute is performed, the position information encoding part 26a and the position code creation part 26b are combined into a position code storage part to store one set of the position code, and the position code may be always used.

When the identification information is inputted, the identification information encoding part 26c encodes the identification information by a specified encoding system. For this encoding, a similar system to that used for the encoding of the position information can be used.

The identification code creation part 26d converts the encoded identification information into a format of embedding as the code information. For example, the arrangement of respective bits in the encoded identification information can be changed or encrypted by a pseudo random number or the like, so that decoding by a third party becomes difficult. Besides, in the case where the identification code is two-dimensionally arranged, bit values are two-dimensionally arranged similarly to the arrangement of the code.

The code arrangement part 26g synthesizes the encoded position information arranged in the same format as the code and the encoded identification information, and creates a two-dimension code array equivalent to an output image size. At this time, the code obtained by encoding the position information different according to the arrangement position is used as the encoding position information, and the code obtained by encoding the same information independently of the position is used as the encoding identification information.

The pattern image creation part 26i confirms bit values of array elements in the two-dimensional code array, acquires a bit pattern image corresponding to each bit value from the pattern storage part 26h, and outputs it as the code image obtained by creating a picture of the two-dimensional code array.

Incidentally, these function portions are realized with the cooperation of software and hardware resources. Specifically, a not-shown CPU of the identification information management server 200 reads a program to realize the respective functions of the reception part 20a, the correspondence information management part 21, the information separation part 23, the document image creation part 24, the code image creation part 26, the image synthesis part 28 and the transmission part 20b from an external storage device into a main storage device and performs the processing.

Next, a description will be given to an operation at the time when this identification information management server 200 transmits the image output instruction to the image forming apparatus 400 in accordance with the instruction from the terminal apparatus 100.

In the identification information management server 200, first, the reception part 20a receives the print instruction including the designation of the storage place of the electronic document of the print object and the print attribute from the terminal apparatus 100. Among the received information, the print attribute is delivered to the correspondence information management part 21, and the correspondence information management part 21 holds this print attribute. Besides, the storage place of the electronic document is delivered to the transmission part 20b, and the transmission part 20b transmits, to the document management server 300, the request to acquire the electronic document of the print object from this storage place.

By this, the document management server 300 transmits the electronic document of the print object to the identification information management server 200, and in the identification information management server 200, the reception part 20a receives this electronic document, and delivers it to the correspondence information management part 21. The correspondence information management part 21 extracts identification information from the identification information repository 250, and registers the correspondence between the identification information and the storage place of the electronic document into the correspondence information DB 22. In the case where a link is made to an electronic document of a reference object by designating a specific position of the electronic document of the print object, the correspondence between the position information and the storage place of the electronic document of the reference object is also registered into the correspondence information DB 22.

When the information is registered into the correspondence information DB 22 as stated above, the correspondence information management part 21 delivers the electronic document, the identification information, and the previously held print attribute to the information separation part 23.

The information separation part 23 separates the delivered information into information (identification information and print attribute) necessary for code creation and information (electronic document) necessary for creation of the document image, outputs the former to the code image creation part 26 and outputs the latter to the document image creation part 24.

By this, the position information corresponding to the print attribute is encoded in the position information encoding part 26a, and the position code indicating the encoded position information is created in the position code creation part 26b. Besides, the identification information is encoded in the identification information encoding part 26c, and the identification code indicating the encoded identification information is created in the identification code creation part 26d.

The two-dimensional code array corresponding to the output image size is created by the code arrangement part 26g, and the pattern image corresponding to the two-dimensional code array is created by the pattern image creation part 26i.

On the other hand, the document image creation part 24 creates the document image of the electronic document.

Finally, the document image created in this document image creation part 24 and the code image previously created by the code image creation part 26 are synthesized by the image synthesis part 28, and are delivered to the transmission part 20b. By this, the transmission part 20b transmits the output instruction of the image after the synthesis to the image forming apparatus 400.

In accordance with this image output instruction, the image forming apparatus 400 prints the composite image of the document image of the electronic document of the print object and the code image on the medium, and the user obtains the printed material 500.

Here, the image forming apparatus 400 will be described.

When receiving the composite image of the code image and the document image, the image forming apparatus 400 prints out the received image, and as a mechanism of the image formation, that of an existing laser printer can be used. However, the image forming apparatus 400 forms the code image by using a color material which can not be easily distinguished (almost invisible) by human eye, and forms the document image by using a color material which is distinguishable (visible) by human eye. Besides, as the invisible color material, one having a property that a wavelength of a specific infrared region is more absorbed than a wavelength of a visible region is used, and as the visible color material, one having a property that a wavelength of a visible region is more absorbed is used.

Incidentally, in this embodiment, although the example of using the invisible color material has been described, the invention is not limited to this. For example, the code image may be formed by using a carbon black absorbing a wavelength of an infrared region, and the document image may be formed by using yellow, magenta, and cyan color materials (in these color materials, the absorption amount of infrared wavelength is generally small).

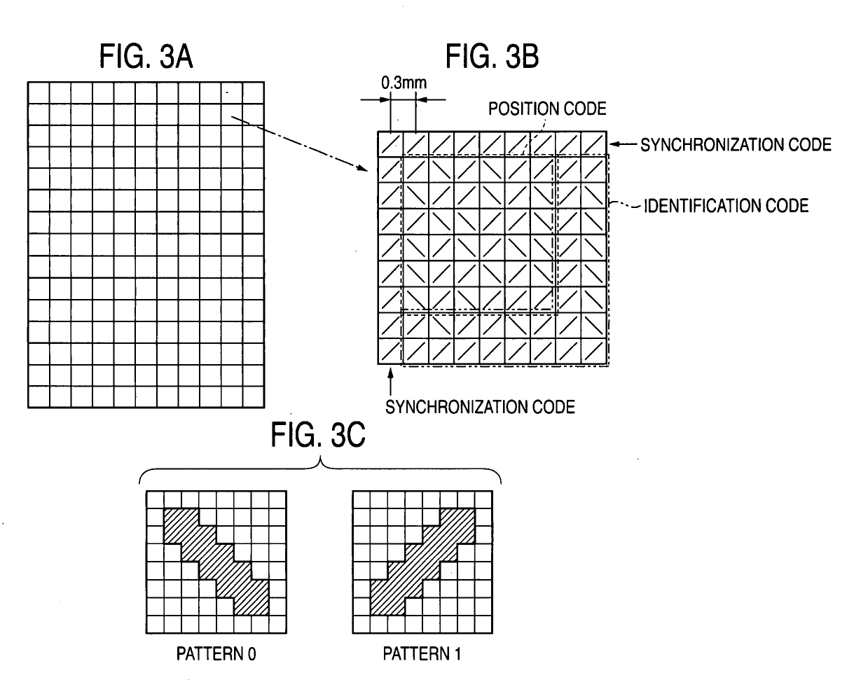

FIGS. 3A to 3C are views for explaining a two-dimensional code image created by the code image creation part 26 of the identification information management server 200 and printed by the image forming apparatus 400. FIG. 3A is a view in which units of the two-dimensional code image formed of an invisible image and arranged are shown in a grid form in order to schematically express them. FIG. 3B is a view showing one unit of the two-dimensional code image in which the invisible image is recognized by infrared light irradiation. Further, FIG. 3C is a view for explaining oblique line patterns of a back slash “\” and a slash “/”.

The two-dimensional code image formed by the image forming apparatus 400 is formed of, for example, an invisible toner in which the maximum absorption rate in the visible light region (400 nm to 700 nm) is, for example, 7% or less, and the absorption rate in the near infrared light region (800 nm to 1000 nm) is, for example, 30% or more. Besides, as the invisible toner, in order to raise the near infrared light absorption capacity necessary for the mechanical readout of the image, one having an average dispersion diameter of 100 nm to 600 nm is adopted. Here, the “visible” and “invisible” do not relate to whether recognition can be made with eyes. The “visible” and “invisible” are distinguished by whether an image formed on a printed medium can be recognized by the existence of the color development property caused by the absorption of a specific wavelength in the visible light region.

The two-dimensional code image shown in FIGS. 3A to 3C is formed of the invisible image in which the mechanical readout by infrared light irradiation and the decoding processing can be stably performed for a long period, and information can be recorded at high density. Besides, the invisible image can be provided in an arbitrary region irrespective of a region of the medium surface where a visible image is provided and the image is outputted. In this embodiment, the invisible image is formed on the whole surface of the medium surface (paper surface) in conformity with the size of the medium to be printed. Besides, the invisible image can be recognized by a difference in luster when a visual check is made. Where, the “whole surface” does not mean including all four corners of a sheet. In an apparatus of an electrophotographic system, since the periphery of a paper surface is generally often a range where printing can not be performed, it is not necessary to print the invisible image in such a range.

The two-dimensional code pattern shown in FIG. 3B includes a region where a position code indicating a coordinate position on the medium is stored, and a region where an identification code to uniquely specify the electronic document or print medium is stored. Besides, a region where a synchronous code is stored is also included. As shown in FIG. 3A, a two-dimensional code in which plural such two-dimensional code patterns are arranged and different position information is stored on the whole surface of the medium surface (paper surface) in conformity with the size of the medium to be printed, is arranged in a grid form. That is, the plural two-dimensional code patterns as shown in FIG. 3B are arranged on the whole surface of the medium, and each of them includes the position code, the identification code, and the synchronous code. Then, position information different according to the place of the arrangement is stored in each of the regions of plural position codes. On the other hand, the same identification information is stored in plural identification code regions independently of the place of the arrangement.

In FIG. 3B, the position code is arranged in a rectangular region of 6 bits×6 bits. Respective bit values are formed of plural minute line bitmaps different in rotation angle, and bit value 0 and bit value 1 are expressed by oblique line patterns (pattern 0 and pattern 1) shown in FIG. 3C. More specifically, the bit 0 and the bit 1 are expressed using the back slash “\” and the slash “/” having inclinations different from each other. The oblique line pattern is constructed at 600 dpi and in a size of 8×8 pixels, the left-upward sloping oblique line pattern (pattern 0) expresses the bit value 0, and the right-upward sloping oblique line pattern (pattern 1) expresses the bit value 1. Accordingly, one oblique line pattern can express one bit information (0 or 1). By using the minute line bitmaps made of the two kinds of inclinations as stated above, it becomes possible to provide the two-dimensional code pattern in which noise given to a visible image is very small, and a large amount of information can be digitized at high density and embedded.

That is, the position information of 36 bits in total is stored in the position code region shown in FIG. 3B. Among 36 bits, 18 bits can be used for the encoding of an X coordinate, and 18 bits can be used for the encoding of a Y coordinate. When all 18 bits are used for the encoding of position, 2¹⁸ (about 260 thousand) positions can be encoded. In the case where each oblique line pattern is constructed of 8 pixels×8 pixels (600 dpi) as shown in FIG. 3C, since one dot in 600 dpi is 0.0423 mm, the size of the two-dimensional code (including the synchronization code) of FIG. 3B becomes about 3 mm (8 pixels×9 bits×0.0423 mm) in both the vertical and horizontal directions. In the case where 260 thousand positions are encoded at intervals of 3 mm, a length of about 786 m can be encoded. As stated above, all the 18 bits may be used for the encoding of position as stated above, or in the case where a detection error of the oblique line pattern occurs, a redundant bit for error detection or error correction may be included.

The identification code is arranged in rectangular regions of 2 bits×8 bits and 6 bits×2 bits, and the identification information of 28 bits in total can be stored. In the case where 28 bits are used for the identification information, 2²⁸ pieces of (about 270 million pieces of) identification information can be expressed. Similarly to the position code, the identification code can also include a redundant bit for error detection or error correction in 28 bits.

Incidentally, in the example shown in FIG. 3C, although the two oblique line patterns are different from each other by 90 degrees in angle, when an angle difference is made 45 degrees, four kinds of oblique line patterns can be constructed. In the case of such a structure, two-bit information (0 to 3) can be expressed by one oblique line pattern. That is, by increasing the angle kinds of the oblique line patterns, the number of expressible bits can be increased.

Besides, in the example shown in FIG. 3C, although encoding of the bit value is described while using the oblique line pattern, the selectable pattern is not limited to the oblique line pattern. It is also possible to adopt a method of performing the encoding by ON/OFF of a dot or by a direction in which dot position is shifted from a reference position.

Next, a description will be given to a structure and an operation of a system for judging whether a rightful user uses the pen device 600 in the case where a character or a figure is described by using the pen device 600 on the printed material 500 obtained in this way.

### First Embodiment

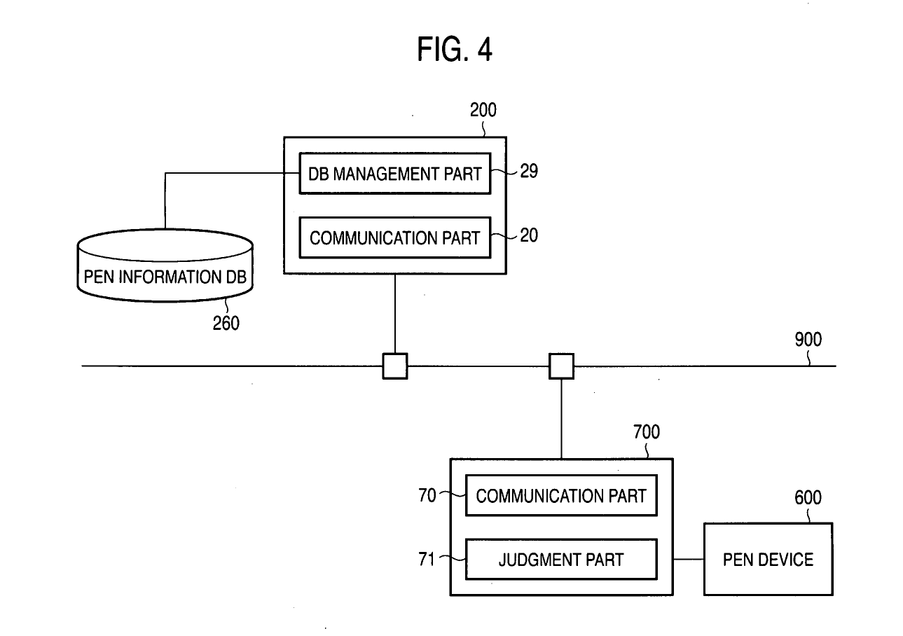

FIG. 4 is a view showing a structural example of a system in a first embodiment.

This system is such that a part of the system shown in FIG. 1 is extracted, and an identification information management server 200 and a terminal apparatus 700 are connected through a network 900. A pen information DB 260 is connected to the identification information management server 200, and a pen device 600 is connected to the terminal apparatus 700. Incidentally, in FIG. 4, although the identification information management server 200 includes the pen information DB 260, a server including the pen information DB 260 may be separately provided. Besides, in FIG. 4, although a portion between the pen device 600 and the terminal apparatus 700 is indicated by a solid line on the assumption that they are connected by wire, as shown in FIG. 1, they may be connected by wireless.

The identification information management server 200 further includes a communication part 20 and a DB management part 29. The communication part 20 is for receiving information from the terminal apparatus 700 or for transmitting information to the terminal apparatus 700, and corresponds to the reception part 20a and the transmission part 20b of FIG. 2. The DB management part 29 performs a search of the pen information DB 260 based on given information.

Besides, the terminal apparatus 700 includes a communication part 70 and a judgment part 71. The communication part 70 is for receiving information from the identification information management server 200 and for transmitting information to the identification information management server 200. The judgment part 71 compares information acquired from the pen device 600 with information received from the identification information management server 200, and judges whether the rightful user uses the pen device 600.

Here, the storage content of the pen information DB 260 will be described.

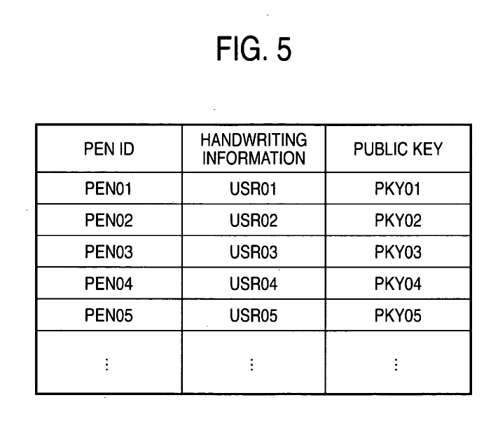

FIG. 5 is a view showing an example of the pen information DB 260.

As shown in the drawing, in the pen information DB 260, identification information (hereinafter referred to as “pen ID”) to uniquely identify the pen device 600, feature information (hereinafter referred to as “handwriting information”) of handwriting of the rightful user of the pen device 600, and a public key previously given to the pen device 600 are made to correspond to one another. Incidentally, although the handwriting information and the public key become generally complicated data, in FIG. 5, for construction reasons, they are simplified and indicated in the form of “USRnn” and “PKYnn”.

Besides, in this embodiment, it is assumed that the public key is given to each of the pen devices 600. Accordingly, even if a rightful user is common to the plural pen devices 600, different public keys are given to the respective pen devices 600. In the example of the drawing, although the rightful users of the pen devices 600 of pen IDs “PENO1” and “PEN04” are the user of handwriting information “USR01”, as the public keys, “PKY01” is given to the pen device 600 of pen ID “PEN01”, and “PKY04” is given to the pen device 600 of pen ID “PEN04”.

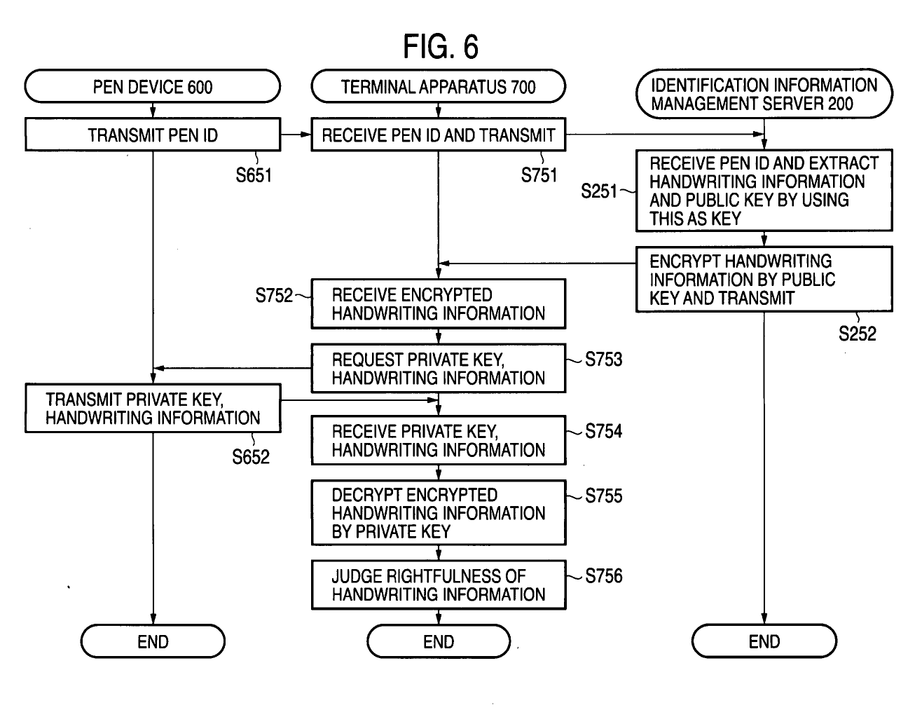

Next, a processing of judging whether a user of the pen device 600 is a rightful user will be described with reference to FIG. 6. Incidentally, it is assumed that a private key (private key corresponding to the public key) given to the pen device 600 is stored in the pen device 600.

When the pen device 600 is used, the pen device 600 transmits the pen ID to the terminal apparatus 700 (step 651). By this, in the terminal apparatus 700, the communication part 70 receives the pen ID, and transmits it to the identification information management server 200 as it is (step 751).

In the identification information management server 200, the communication part 20 receives the pen ID, and the DB management part 29 uses the pen ID as a key and extracts the handwriting information and the public key from the pen information DB 260 (step 251). The DB management part 29 encrypts the handwriting information by the public key, and the communication part 20 transmits the encrypted handwriting information to the terminal apparatus 700 (step 252).

By this, in the terminal apparatus 700, the communication part 70 receives the encrypted handwriting information (step 752), and requests the pen device 600 to transmit the private key and the handwriting information (step 753).

When receiving this request, the pen device 600 transmits the private key stored in the device itself and the handwriting information acquired when a character or a figure is described on a medium such as a sheet to the terminal apparatus 700 (step 652). Incidentally, a mechanism of the pen device 600 to acquire the handwriting information and an acquisition operation of the handwriting information will be described later.

By this, in the terminal apparatus 700, the communication part 70 receives the private key and the handwriting information (step 754). Besides, the information encrypted by the public key received at step 752 is decrypted by this private key (step 755). The handwriting information received at step 754 is compared with the handwriting information obtained by the decryption at step 755, and it is judged whether the user of the pen device 600 is the rightful user (step 756).

As a result, when the user is judged to be the rightful user, the subsequent use of the pen device 600 by the user is permitted. On the other hand, when the user is judged not to be the rightful user, the subsequent use of the pen device 600 by the user is denied.

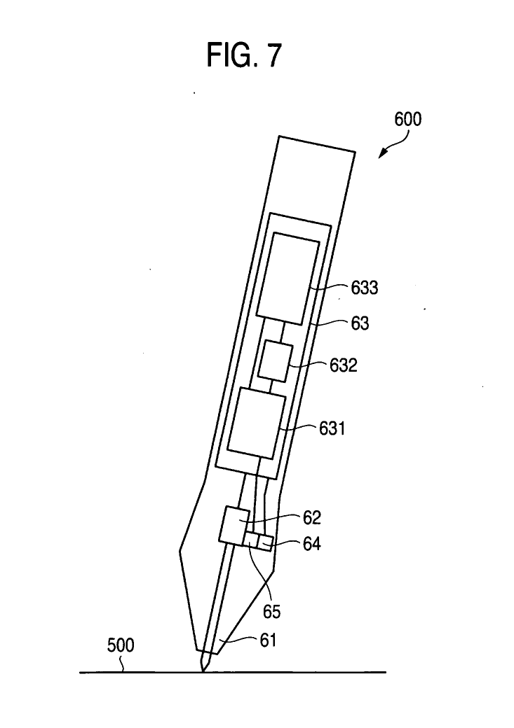

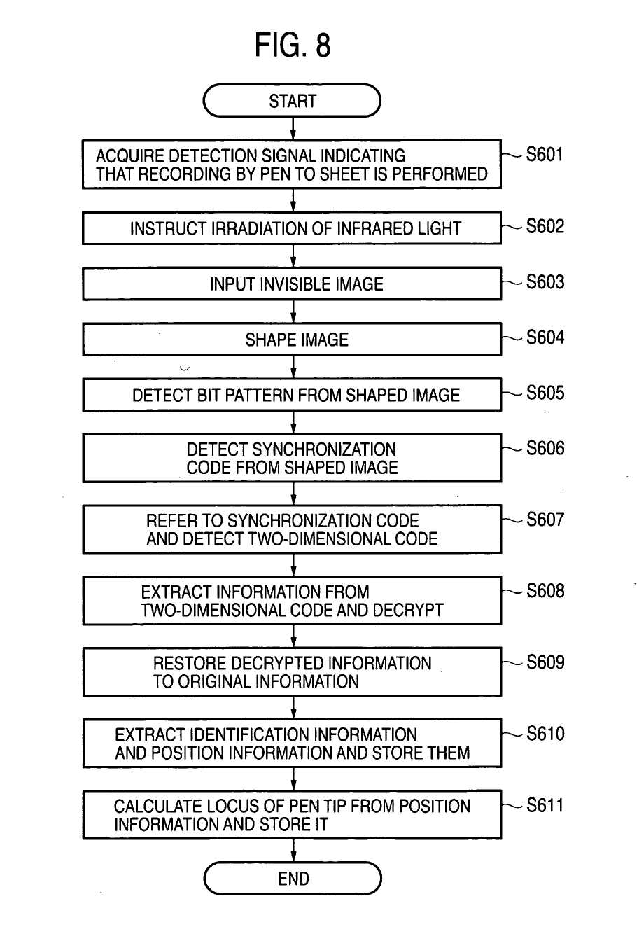

Here, the mechanism of the pen device 600 to acquire the handwriting information and the acquisition operation of the handwriting information will be described with reference to FIGS. 7 and 8.

FIG. 7 is a view showing a structure of the pen device 600.

This pen device 600 includes a writing part 61 to record a character or a figure by a similar operation to a normal pen onto a sheet (medium) on which a code image and a document image are synthesized and printed, and a writing pressure detection part 62 to monitor the motion of the writing part 61 and that the pen device 600 is pressed to the sheet. Besides, the pen device includes a control part 63 to control the whole electric operation of the pen device 600, an infrared irradiation part 64 to irradiate infrared light in order to read the code image on the sheet, and an image input part 65 to recognize and input the code image by receiving the reflected infrared light.

Here, the control part 63 will be further described in detail.

The control part 63 includes a code acquisition part 631, a locus calculation part 632, and an information storage part 633. The code acquisition part 631 is a portion to analyze the image inputted from the image input part 65 and to acquire the code. The locus calculation part 632 is a portion to calculate a locus of a pen tip by correcting a shift between the coordinate of the pen tip of the writing part 61 and the coordinate of the image captured by the image input part 65 with respect to the code acquired by the code acquisition part 631. The information storage part 633 is a portion to store the code acquired by the code acquisition part 631 and the locus information calculated by the locus calculation part 632.

Incidentally, in this embodiment, although not shown, a mechanism to analyze the locus information stored in the information storage part 633 and to acquire handwriting information is also provided.

FIG. 8 is a flowchart showing a processing executed mainly in the control part 63 of the pen device 600. When recording of a character or a figure is performed on the sheet by using the pen device 600, the control part 63 acquires, from the writing pressure detection part 62, a detection signal indicating that recording by the pen is performed to the sheet (step 601). When detecting this detection signal, the control part 63 instructs the infrared irradiation part 64 to irradiate the infrared light to the sheet (step 602). The infrared light irradiated to the sheet by the infrared irradiation part 64 is absorbed by the invisible image and is reflected at a portion other than that. The image input part 65 receives this reflected infrared light, and recognizes the portion where the infrared light is not reflected as the code image. The control part 63 inputs (scans) this code image from the image input part 65 (step 603).

Thereafter, in the code acquisition part 631 of the control part 63, the code image detection processing shown at step 604 to step 610 is executed. First, the code acquisition part 631 shapes the inputted scan image (step 604). The shaping of this scan image includes an inclination correction, noise removal and the like. The bit pattern (oblique line pattern) such as the slash “/” or the back slash “\” is detected from the shaped scan image (step 605). On the other hand, the synchronization code as the two-dimensional code positioning code is detected from the shaped scan image (step 606). The code acquisition part 631 refers to this synchronization code position and detects the two-dimensional code (step 607). Besides, information such as ECC (Error Correcting Code) is extracted from the two-dimensional code and is decrypted (step 608). The decrypted information is restored to the original information (step 609).

The code acquisition part 631 of the control part 63 extracts the position information and the identification information from the code information restored as described above, and stores the extracted information into the information storage part 633 (step 610). On the other hand, the locus calculation part 632 calculates the locus of the pen tip from the coordinate information stored in the information storage part 633, and stores it into the information storage part 633 (step 611).

Thereafter, the handwriting information is acquired from the locus information stored in the information storage part 633, and is transmitted to the terminal apparatus 700.

From the above, the operation of this embodiment is ended.

Incidentally, in this embodiment, although the handwriting information and the public key are stored in the pen information DB 260, what is obtained by encrypting the handwriting information by the public key may be stored. In that case, at step 251 of FIG. 6, the handwriting information encrypted by the public key is extracted from the pen information DB 260, and is directly transmitted to the terminal apparatus 700 without performing the encryption processing at step 252.

### Second Embodiment

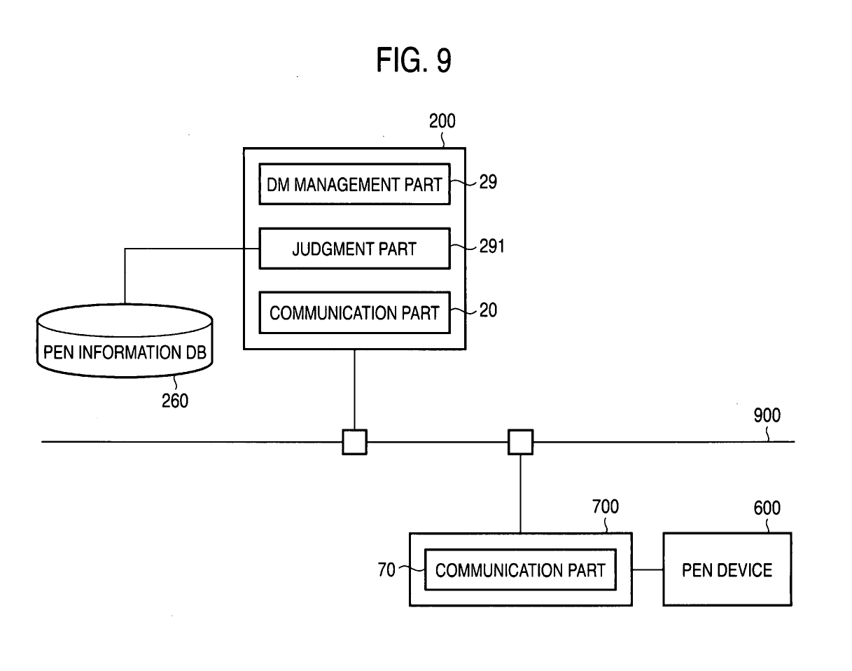

FIG. 9 is a view showing a structural example of a system in a second embodiment.

This system is such that a part of the system shown in FIG. 1 is extracted, and an identification information management server 200 and a terminal apparatus 700 are connected through a network 900. Besides, the identification information management server 200 is connected with a pen information DB 260, and the terminal apparatus 700 is connected with a pen device 600. Incidentally, in FIG. 9, although the identification information management server 200 includes the pen information DB 260, a server including the pen information DB 260 maybe separately provided. Besides, in FIG. 9, although a portion between the pen device 600 and the terminal apparatus 700 is indicated by a solid line on the assumption that they are connected by wire, as shown in FIG. 1, they may be connected by wireless.

In this second embodiment, a judgment device to judge whether a rightful user uses the pen device 600 is not provided in the terminal apparatus 700 as in the first embodiment, but is provided in the identification information management server 200. That is, a judgment part 291 compares information transmitted from the terminal apparatus 700 acquired from the pen device 600 with information acquired from the pen information DB 260, and judges whether the rightful user uses the pen device 600.

Incidentally, since the storage content of the pen information DB 260 is similar to that described in the first embodiment, its description will be omitted here.

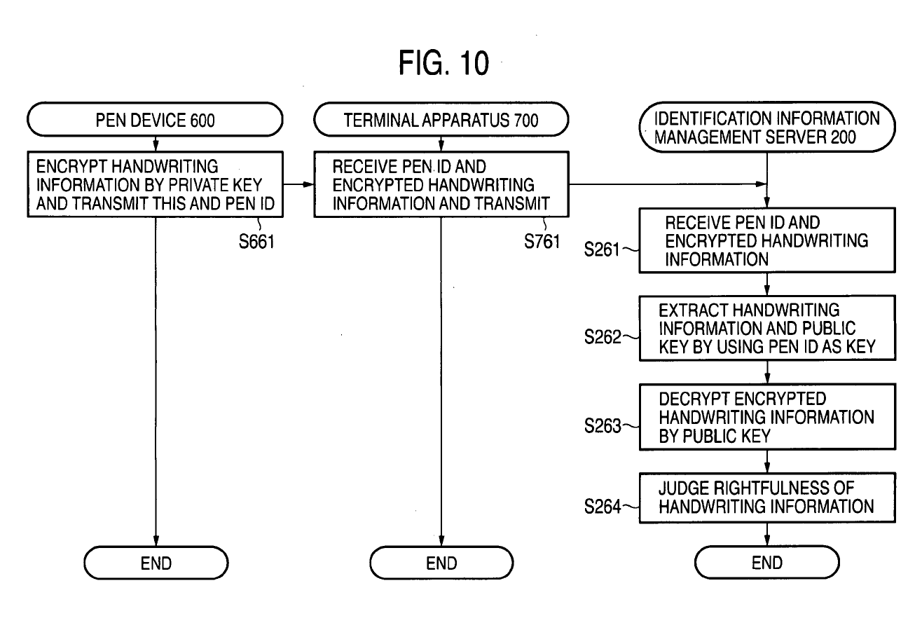

Next, a processing of judging whether the user of the pen device 600 is the rightful user will be described with reference to FIG. 10. Incidentally, also in this embodiment, it is assumed that a private key (private key corresponding to the public key) given to the pen device 600 is stored in the pen device 600. Besides, in this embodiment, although the handwriting information is first acquired by the pen device 600, since the mechanism to acquire the handwriting information and the acquisition operation of the handwriting information are similar to those described in the first embodiment, their detailed description will be omitted.

When the pen device 600 is used, the pen device 600 encrypts the acquired handwriting information by the private key stored in the device itself, and transmits the encrypted handwriting information and the pen ID to the terminal apparatus 700 (step 661). By this, in the terminal apparatus 700, the communication part 70 receives the pen ID and the encrypted handwriting information, and transmits them to the identification information management server 200 as they are (step 761).

In the identification information management server 200, the communication part 20 receives the pen ID and the encrypted handwriting information (step 261). The DB management part 29 uses the received pen ID as a key and extracts the handwriting information and the public key from the pen information DB 260 (step 262). Besides, the handwriting information received at step 261 is decrypted by the public key extracted at step 262 (step 263). Finally, the judgment part 291 compares the handwriting information extracted at step 262 with the handwriting information obtained by the decryption at step 263, and judges whether the user of the pen device 600 is the rightful user (step 264).

As a result, when the user is judged to be the rightful user, the subsequent use of the pen device 600 by the user is permitted. On the other hand, when the user is judged not to be the rightful user, the subsequent use of the pen device 600 by the user is denied.

By the above, the operation of this embodiment is ended.

Incidentally, although the handwriting information and the public key are stored in the pen information DB 260, what is obtained by encrypting the handwriting information by the public key may be stored. In that case, at step 262 of FIG. 10, the handwriting information encrypted by the public key is extracted from the pen information DB 260, and at step 263, after decryption by the public key, the encryption processing is further performed by the same public key. At step 264, the handwriting information encrypted by the public key extracted at step 262 is compared with the handwriting information encrypted by the public key at step 263.

In the first and the second embodiments, in order to judge whether the user of the pen device 600 is the rightful user, the handwriting information is used. However, as long as the user can be specified, any feature information may be used.

Such information includes, for example, the following.

“Biometric information such as a fingerprint, vein information of a palm, DNA information, and an iris”

Among these, the information of the fingerprint, the vein, and the iris can be acquired by, for example, providing the pen device 600 with a small camera for photographing the information. Besides, the DNA information can be acquired by providing the pen device 600 with a sampling tool used in an existing DNA sampling kit.

“Identification information such as an ID of an IC card always carried by a user”

In recent years, there has appeared an IC card, such as an employee ID card, having a non-contact near distance communication function such as RFID (Radio Frequency Identification). Accordingly, identification information such as employee number is read from such an IC card, and can also be used as the information to specify the rightful user of the pen device 600.

As described above, in the embodiment, the pen device and the feature information of the rightful user are stored in the database. When the pen device is used, a check is made against the database, so that it becomes possible to judge whether the rightful user uses the pen device.

Besides, transmission/reception of information between the apparatus including the pen device and the apparatus including the database is encrypted by using the public key and the private key and is performed, so that it maybe possible to prevent the dishonest use of the pen device.

As described above, some embodiments of the invention are outlines below.

According to an aspect of the invention, a pen device and feature information of a rightful user thereof are stored in a database, and the rightful user is discriminated based on this. That is, according to an aspect of the invention, a user discrimination system includes a database to store a correspondence between a pen device and feature information of a rightful user of the pen device, a database management part to acquire, when the pen device is used, the feature information corresponding to the pen device from the database, and a judgment part to judge, based on the feature information acquired from the database and feature information of a user of the pen device acquired from the pen device, whether the user is the rightful user.

In the user discrimination system, the database management part may exist in a first computer connected to the database, the judgment part may exist in a second computer capable of communicating with the pen device, and the first computer and the second computer may be connected through a communication line.

In the user discrimination system, the pen device may be given a public key and a private key, the database may store the feature information of the rightful user of the pen device in a state where it is not encrypted by the public key, and the judgment part may receive encrypted feature information obtained by encrypting the feature information by the public key from the first computer and may judge whether the user is the rightful user by comparing feature information obtained by decrypting the encrypted feature information by the private key with the feature information of the user of the pen device acquired from the pen device.

In the user discrimination system, the pen device may be given a public key and a private key, the database may store the feature information of the rightful user of the pen device as encrypted feature information obtained by encrypting the feature information by the public key, and the judgment part may receive the encrypted feature information from the first computer and may judge whether the user is the rightful user by comparing feature information obtained by decrypting the encrypted feature information by the private key with the feature information of the user of the pen device acquired by the pen device.

In the user discrimination system, the database management part and the judgment part may exist in a first computer connected to the database, and the first computer may be connected to a second computer capable of communicating with the pen device through a communication line.

In the user discrimination system, the pen device may be given a public key and a private key, the database may store the feature information of the rightful user of the pen device in a state where it is not encrypted by the public key, and the judgment part may receive, from the second computer, encrypted feature information obtained by encrypting the feature information of the user of the pen device acquired from the pen device by the private key and may judge whether the user is the rightful user by comparing feature information obtained by decrypting the encrypted feature information by the public key with the feature information acquired from the database.

In the user discrimination system, the pen device may be given a public key and a private key, the database may store the feature information of the rightful user of the pen device as encrypted feature information encrypted by the public key, and the judgment part may receive, from the second computer, information obtained by encrypting the feature information of the user of the pen device acquired from the pen device by the private key and may judge whether the user is the rightful user by comparing encrypted feature information obtained by decrypting the information by the public key and by further encrypting it by the public key with the encrypted feature information acquired from the database.

In the user discrimination system, the feature information may be handwriting information of the user of the pen device.

In the user discrimination system, the handwriting information may be obtained by irradiating infrared light to a medium on which position information is printed using an infrared light absorption toner.

In the user discrimination system, the feature information may be biometric information of the user of the pen device.

In the user discrimination system, the feature information may be identification information of a non-contact type IC tag owned by the user of the pen device.

According to another aspect of the invention, in a case where a user discrimination system includes a first computer including a database and a second computer including a pen device, the invention can also be recognized as a user discrimination method for judging rightfulness of a user by the second computer. In that case, the user discrimination method includes storing a correspondence between the pen device and feature information of a rightful user of the pen device into the database by the first computer, transmitting, when the pen device is used, information to specify the pen device from the second computer to the first computer, acquiring feature information corresponding to the pen device from the database by the first computer, transmitting the acquired feature information or encrypted feature information obtained by encrypting the feature information from the first computer to the second computer, and judging, based on the feature information or the encrypted feature information received from the first computer and feature information of a user of the pen device acquired from the pen device, by the second computer, whether the user is the rightful user.

In the user discrimination method, the pen device may be given a public key and a private key, the feature information of the rightful user of the pen device may be stored in a state where it is not encrypted by the public key, encrypted feature information obtained by encrypting the feature information acquired from the database by the public key may be transmitted, and it may be judged whether the user is the rightful user by comparing feature information obtained by decrypting the encrypted feature information received from the first computer by the private key with the feature information of the user of the pen device acquired from the pen device.

In the user discrimination method, the pen device may be given a public key and a private key, encrypted information obtained by encrypting the feature information of the rightful user of the pen device by the public key may be stored, the encrypted feature information acquired from the database may be transmitted to the second computer, and it may be judged whether the user is the rightful user by comparing feature information obtained by decrypting the encrypted feature information received from the first computer by the private key with the feature information of the user of the pen device acquired from the pen device.

Besides, according to another aspect of the invention, the invention can be recognized as a user discrimination method for judging rightfulness of a user by a first computer. In that case, the user discrimination method includes storing a correspondence between a pen device and feature information of a rightful user of the pen device into a database by the first computer, transmitting, when the pen device is used, information to specify the pen device and feature information of a user of the pen device acquired by the pen device from a second computer to the first computer, acquiring feature information corresponding to the pen device from the database by the first computer, and judging, based on the feature information of the user received from the second computer and the feature information acquired from the database, by the first computer, whether the user is the rightful user.

In the user discrimination method, the pen device may be given a public key and a private key, the feature information of the rightful user of the pen device may be stored in a state where it is not encrypted by the public key, encrypted feature information obtained by encrypting the feature information acquired by the pen device by the private key may be transmitted, and it may be judged whether the user is the rightful user by comparing feature information obtained by decrypting the encrypted feature information received from the second computer by the public key with the feature information acquired from the database.

In the user discrimination method, the pen device may be given a public key and a private key, encrypted information obtained by encrypting the feature information of the rightful user of the pen device by the public key may be stored, the information obtained by encrypting the feature information acquired by the pen device by the private key may be transmitted, and encrypted feature information obtained by decrypting the information received from the second computer by the public key and by further encrypting it by the public key may be compared with the encrypted feature information acquired from the database.

On the other hand, according to another aspect of the invention, the invention can be recognized as a storage medium readable by a computer and storing a program of instructions executable by the computer to perform a specified function.

First, a storage medium readable by a computer stores a program of instructions executable by a second computer including a pen device to perform a specified function. In that case, the storage medium stores the program of instructions executable by the computer to perform the function, and the function comprises: transmitting, when the pen device is used, information to specify the pen device to another computer; receiving feature information of a rightful user of the pen device from another computer; and judging, based on the received feature information and feature information of a user of the pen device acquired from the pen device, whether the user is the rightful user.

Second, a storage medium readable by a computer stores a program of instructions executable by a first computer including a database to perform a specified function. In that case, the storage medium stores the program of instructions executable by the computer to perform the function, and the function includes: receiving, when a pen device is used, information to specify the pen device and feature information of a user of the pen device acquired from the pen device; acquiring feature information of a rightful user of the pen device; and judging whether the user is the rightful user based on the received feature information of the user and the acquired feature information.

According to an aspect of the invention, it becomes possible to judge whether a rightful user uses a pen device.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-186898 filed on Jun. 27, 2005 including specification, claims, drawings and abstract is incorporated herein by reference in its entirety.

What is claimed is:

1. A user discrimination system comprising:
a database to store a correspondence between a pen device and feature information of a rightful user of the pen device;
a database management part to acquire the feature information corresponding to the pen device from the database when the pen device is used; and
a judgment part to judge whether the user is the rightful user based on the feature information acquired from the database and feature information of a user of the pen device acquired from the pen device.

2. The user discrimination system according to claim 1, wherein
the database management part exists in a first computer connected to the database,
the judgment part exists in a second computer capable of communicating with the pen device, and
the first computer and the second computer are connected through a communication line.

3. The user discrimination system according to claim 2, wherein
the pen device is given a public key and a private key,
the database stores the feature information of the rightful user of the pen device in a state where it is not encrypted by the public key, and
the judgment part receives encrypted feature information obtained by encrypting the feature information by the public key from the first computer, and judges whether the user is the rightful user by comparing feature information obtained by decrypting the encrypted feature information by the private key with the feature information of the user of the pen device acquired from the pen device.

4. The user discrimination system according to claim 2, wherein
the pen device is given a public key and a private key,
the database stores the feature information of the rightful user of the pen device as encrypted feature information obtained by encrypting the feature information by the public key, and
the judgment part receives the encrypted feature information from the first computer and judges whether the user is the rightful user by comparing feature information obtained by decrypting the encrypted feature information by the private key with the feature information of the user of the pen device acquired from the pen device.

5. The user discrimination system according to claim 1, wherein
the database management part and the judgment part exist in a first computer connected to the database, and
the first computer is connected to a second computer capable of communicating with the pen device through a communication line.

6. The user discrimination system according to claim 5, wherein
the pen device is given a public key and a private key,
the database stores the feature information of the rightful user of the pen device in a state where it is not encrypted by the public key, and
the judgment part receives, from the second computer, encrypted feature information obtained by encrypting the feature information of the user of the pen device acquired from the pen device by the private key, and judges whether the user is the rightful user by comparing feature information obtained by decrypting the encrypted feature information by the public key with the feature information acquired from the database.

7. The user discrimination system according to claim 5,
wherein the pen device is given a public key and a private key,
the database stores the feature information of the rightful user of the pen device as encrypted feature information encrypted by the public key, and
the judgment part receives, from the second computer, information obtained by encrypting the feature information of the user of the pen device acquired from the pen device by the private key, and judges whether the user is the rightful user by comparing encrypted feature information obtained by decrypting the information by the public key and by further encrypting it by the public key with the encrypted feature information acquired from the database.

8. The user discrimination system according to claim 1, wherein the feature information is handwriting information of the user of the pen device.

9. The user discrimination system according to claim 8, wherein the handwriting information is obtained by irradiating infrared light to a medium on which position information is printed using a toner including an infrared light absorbing material.

10. The user discrimination system according to claim 1, wherein the feature information is biometric information of the user of the pen device.

11. The user discrimination system according to claim 1, wherein the feature information is identification information of a non-contact type IC tag owned by the user of the pen device.

12. A user discrimination method comprising:
storing a correspondence between a pen device and feature information of a rightful user of the pen device into a database by a first computer;
transmitting, when the pen device is used, information to specify the pen device from a second computer to the first computer;
acquiring the feature information corresponding to the pen device from the database by the first computer;
transmitting the acquired feature information or encrypted feature information obtained by encrypting the feature information from the first computer to the second computer; and
judging whether the user is the rightful user or not by the second computer based on the feature information or the encrypted feature information received from the first computer and feature information of a user of the pen device acquired from the pen device.

13. The user discrimination method according to claim 12, wherein
the pen device is given a public key and a private key,
the feature information of the rightful user of the pen device is stored in a state where it is not encrypted by the public key,
encrypted feature information obtained by encrypting the feature information acquired from the database by the public key is transmitted from the first computer to the second computer, and
it is judged whether the user is the rightful user by comparing feature information obtained by decrypting the encrypted feature information received from the first computer by the private key with the feature information of the user of the pen device acquired from the pen device.

14. The user discrimination method according to claim 12, wherein
the pen device is given a public key and a private key,
encrypted information obtained by encrypting the feature information of the rightful user of the pen device by the public key is stored,
the encrypted feature information acquired from the database is transmitted to the second computer, and
it is judged whether the user is the rightful user by comparing feature information obtained by decrypting the encrypted feature information received from the first computer by the private key with the feature information of the user of the pen device acquired from the pen device.

15. A user discrimination method comprising:
storing a correspondence between a pen device and feature information of a rightful user of the pen device into a database by a first computer;
transmitting, when a pen device is used, information to specify the pen device and feature information of a user of the pen device acquired from the pen device from a second computer to the first computer;
acquiring the feature information corresponding to the pen device from the database by the first computer; and
judging whether the user is the rightful user or not by the first computer based on the feature information of the user received from the second computer and the feature information acquired from the database,.

16. The user discrimination method according to claim 15, wherein
the pen device is given a public key and a private key,
the feature information of the rightful user of the pen device is stored in a state where it is not encrypted by the public key,
encrypted feature information obtained by encrypting the feature information acquired from the pen device by the private key is transmitted, and
it is judged whether the user is the rightful user by comparing feature information obtained by decrypting the encrypted feature information received from the second computer by the public key with the feature information acquired from the database.

17. The user discrimination method according to claim 15, wherein
the pen device is given a public key and a private key,
encrypted information obtained by encrypting the feature information of the rightful user of the pen device by the public key is stored,
information obtained by encrypting the feature information acquired from the pen device by the private key is transmitted, and
encrypted feature information obtained by decrypting the information received from the second computer by the public key and by further encrypting it by the public key is compared with the encrypted feature information acquired from the database.

18. A storage medium readable by a computer, the storage medium storing a program of instructions executable by the computer to perform a function, the function comprising:
transmitting information to specify the pen device to another computer when a pen device is used;
receiving feature information of a rightful user of the pen device from the another computer; and
judging whether the user is the rightful user or not based on the received feature information and feature information of a user of the pen device acquired from the pen device.

19. A storage medium readable by a computer, the storage medium storing a program of instructions executable by the computer to perform a function, the function comprising:
receiving information to specify the pen device and feature information of a user of the pen device acquired from the pen device, when a pen device is used;
acquiring feature information of a rightful user of the pen device; and
judging whether the user is the rightful user or not based on the received feature information of the user and the acquired feature information.
